(19) United States
(12) Patent Application Publication
(10) Pub. No.: US 2010/0258481 A1
(43) Pub. Date: Oct. 14, 2010

(54) SIFTING SCREEN

(76) Inventor: Nashat N. Helmy, West Bloomington, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 12/422,461

(22) Filed: Apr. 13, 2009

(51) Int. Cl. B07B 1/46

(52) U.S. Cl. 209/275; 209/405

(57) ABSTRACT

A screen for sifting particles of a material being processed. The screen includes a portion having an apertured matrix. The matrix is defined by intersecting, generally elastic material segments. A frame extends around at least a portion of a periphery of the matrix. The frame can mount hooks for attaching the sifting screen to a shaker bed which vibrates the matrix. The elasticity of the matrix renders the matrix flexible and stretchable so that the screen portion of the sifting screen can be attached to a shaker bed.

### TECHNICAL FIELD

The present invention deals broadly with sifting granular material to sequentially classify materials based upon size. More narrowly, however, it deals with machines which effect shaking of the material to be classified in order to facilitate maintenance of a sifting screen in an unoccluded disposition.

### BACKGROUND OF THE INVENTION

Large aggregate sifting machinery for classifying material by size is well-known in the art. A number of problems are, however, prevalent with regard to such machinery. One problem is cost. Because of typically rapid deterioration, the useful life of an apparatus can be quite short.

Another problem is clogging. Frequently, ambient dust can accumulate and fill holes through which the material to be classified passes. Depending upon various conditions such as moisture, obstruction of apertures can render such machinery at least temporarily non-operational.

A final concern deals with transportability. Any number of components of such a sifting apparatus can be quite heavy, and such a machine can be rendered virtually immobile.

It is to these shortcomings and problems of the prior art that the present invention is directed. It is an improved sifting apparatus which addresses these problems and shortcomings. Because of the construction of an apparatus in accordance with the present invention, these shortcomings are overcome.

### SUMMARY OF THE INVENTION

The invention is a sifting screen which includes a screen portion. The screen portion, in turn, employs an apertured matrix defined by the intersection of segments which form the matrix. The matrix is made primarily of an elastomeric material having elastic properties that allow the screen to operate under high tension without significant yield. A frame extends about at least a portion of the periphery of the matrix. The frame mounts a plurality of hooks to the matrix of the screen portion and to a shaker bed. With the matrix so disposed, the sifting screen can be used to sift a particular volume of material. The frame is shaped and sized relative to locations of attachment to the shaker bed.

In the present invention, the matrix is formed primarily of a material having a desired elasticity. The frame extends about at least a portion of a periphery of the matrix. It thereby defines the screen portion which enables stretching and mounting to a shaker bed. Sifting operations are, thereby, able to be performed.

The frame is sized and shaped relative to locations of attachment to the shaker bed. The matrix is afforded a degree of elasticity, as previously discussed, so that mounting of the screen portion to the shaker bed is accomplished by stretching and tensioning the matrix in such a way so as to form the screen over the bucker bar of the shaker bed. The screen portion is defined in part by a pair of opposite, generally arcuate, non-parallel edges, each of which has a relatively long radius of curvature. Mounting the screen portion to the shaker bed in a manner wherein alternate parallel edges carry mounting hooks causes the matrix surfaces to vibrate during sifting operations, wherein it generates a wave-like motion having longitudinal movement as well as surface vibration. Vibration of the matrix facilitates cleaning of the apparatus and does not permit specific particles and fine powder to accumulate. Consequent occluding of apertures in the screen portion is thereby obviated.

It will be understood that, because of the elastic nature of the matrix, it can be folded for transportation. This enables the apparatus to be quite mobile.

The invention is thus an improved sifting screen apparatus. More specific features and advantages obtained in view of those features will become apparent with reference to the DETAILED DESCRIPTION OF THE INVENTION, appended claims and accompanying drawing figures.

### BRIEF DESCRIPTION OF THE DRAWINGS

FIG. 1 is a top plan view of the screen portion of a sifting screen mechanism in accordance with the present invention;

FIG. 2 is a sectional view of a segment of a screen portion frame in accordance with the present invention; and

FIG. 3 is a top plan view illustrating an alternative, modular embodiment.

### DETAILED DESCRIPTION OF THE INVENTION

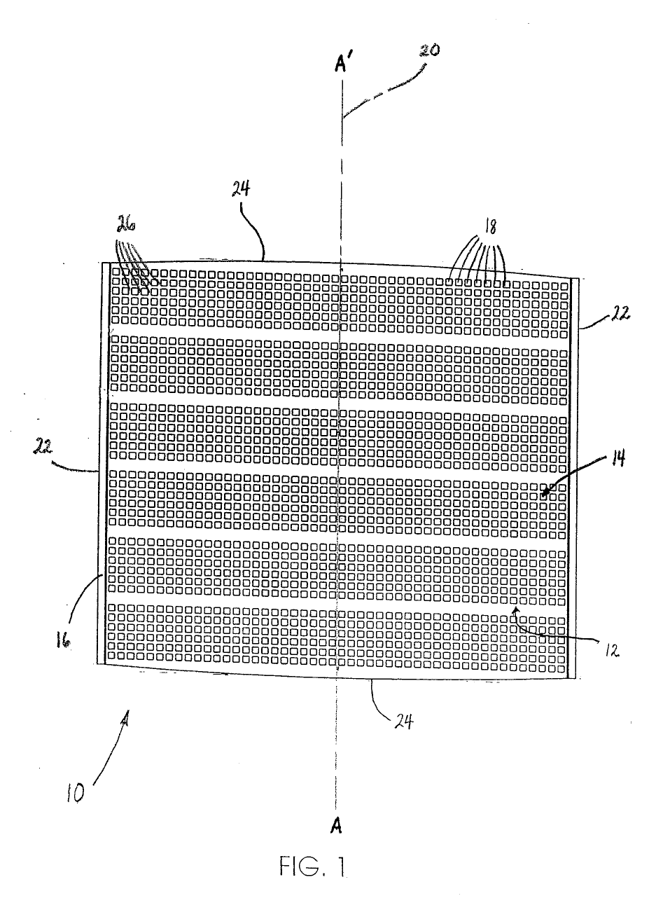

Referring now to the drawing figures wherein like reference numerals denote like elements throughout the several views, FIG. 1 illustrates a sifting screen 10 in accordance with the present invention. The screen 10 includes a screen portion 12 formed by an apertured matrix 14. The matrix 14 is formed from an elastomeric material. Typically, the matrix 14 is homogeneously elastomeric being formed of a material such as polyurethane, rubber or another polymer, when tensioned, having a low yield with a targeted modulus of elasticity. The elastic nature of the matrix 14 is for a purpose discussed hereinafter. The matrix 14 is formed by a multiplicity of intersecting, elastic segments 26 of material. The intersecting segments 26 thereby define a multiplicity of apertures 18 through which a granular-like material can pass during a sifting operation of the screen 10.

The overall sifting screen 10 is typically substantially rectangular in shape, but it can assume other geometric configurations. It is defined by a pair of opposite, substantially linear edges 22 which extend parallel to, and on opposite sides of, a central axis 20. Further, edges 24 of the sifting screen are defined by slightly outwardly bowed portions. The arcuate, bowed edges have a relatively large radius of curvature. Consequently, the bowing is relatively slight.

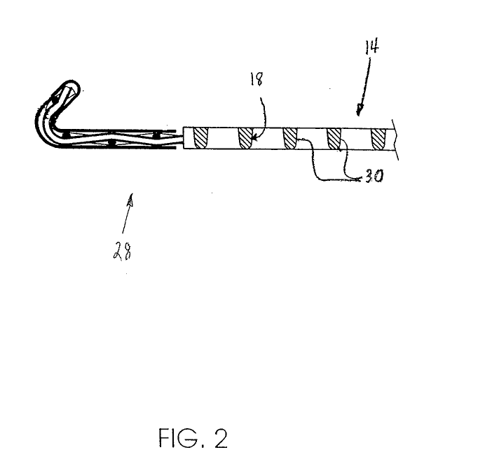

Lateral edges 22 further provide frame sections 16. These sections 16 would, it is intended, mount a plurality of hook members 28 as best seen in FIG. 2. Hook members 28 are, typically, of a type and design as known in the prior art. They can be mounted along the generally parallel, lateral edges 22 of sifting screen 10. They can be spaced at appropriate intervals for cooperative engagement with corresponding locations on a shaker bed (not shown).

As previously discussed, the screen portion and matrix 14 thereof are elastomeric in nature. The degree of this attribute afforded to the matrix 14 is a calculated figure which will enable the matrix 14 to be both stretched for mounting and appropriately tensioned to facilitate optimum operation of the sifting screen 10.

The bowing of forward and rearward edges 24 enables the sifting screen 10, in operation, to not only vibrate to accomplish sifting of a granular material placed on an upper side thereof. Further, in view of the tensioning of the bowed edges 24, longitudinal movement of the media along the screen portion will also be enabled. This results from the generation of a wave-like motion during sifting operations. When the screen is in tension along the A-A′ axis, the entire screen is subject to linear tension, for the most part, from one hook to another. This force tends to draw the screen sides 24 inward toward each other during operation at a high sifting motion and will display a vertical surface vibration with a wave-like profile perpendicular to the A-A′ plane. This phenomenon cannot be displayed in a rigid structure such as woven or welded wire screen or flat modular screen.

As will be best seen in FIG. 2, the apertures 18 defined in the matrix 14 are, it is intended, defined by tapered walls 30, an aperture 18 having a smaller area at the top thereof than at the bottom.

A sifting screen 10 thus structured is enabled to solve problems of the prior art. While the material forming the matrix 14 is not as strong as a more rigid material, it is more elastic and vibrant which allows for a high number of operating hours. It is also significantly less expensive. Consequently, the cost per time unit of operational life achieved is more desirable.

Further, the sifting screen 10 in accordance with the present invention serves to optimize sifting operations. Because of the shape of apertures 18, occluding is deterred. Occlusion is, however, also deterred by the vibration and longitudinal movement of the media being sifted. These motions, since they occur in unison, do not cause deformation of the screen opening, thus keeping the grading very much within the desired mix. In contrast, with thin wire, when vibrating, the opening gets bigger and the larger particles will go through causing an off spec material.

The invention also facilitates transportability of the sifting screen 10. The elastomeric materials used in manufacturing the matrix 14 tend to be considerably lighter than other materials used on sifting screens in the prior art and are foldable.

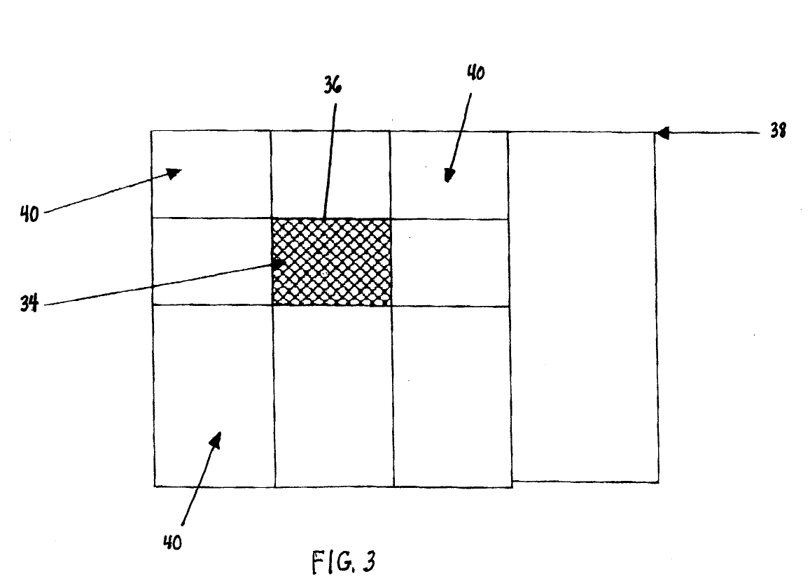

A further embodiment of the invention (illustrated in FIG. 3) is one which employs modular elements 34 wherein each can be stretched and mounted on a small modular frame 36. The modular frames 36, in turn, are fixed on a large flat frame 38. While such an embodiment adds to the complexity of the apparatus, greater versatility is achieved. The modular elements 34, when they are stretched along their edges, seal the edge of the overall apparatus along tension rails. Further, they also create the longitudinal motion previously discussed so that the screen assembly will vibrate up and down and move in a wave-like profile.

FIG. 3 illustrates a large flat frame 38 capable of receiving multiple modular elements 34. It will be understood that, while only one such element 34 is illustrated, that figure illustrates multiple other loci 40 at which small modular elements 34 could be attached.

It will be understood that this disclosure, in many respects, is only illustrative. Changes may be made in details, particularly in matters of shape, size, material, and arrangement of parts without exceeding the scope of the invention. Accordingly, the scope of the invention is as defined in the language of the appended claims.

What is claimed is:

1. A sifting screen, comprising:
a screen portion including an apertured matrix defined by intersecting segments, said matrix being formed primarily of an elastomeric material; and
a frame, extending about at least a portion of a periphery of said matrix, for mounting said screen portion to a shaker bed for sifting;
wherein said frame is sized and shaped relative to locations of attachment to the shaker bed and said matrix has a degree of elasticity such that mounting of said screen portion to the shaker bed is accomplished by stretching and tensioning said matrix.

2. A sifting screen in accordance with claim 1 wherein, during sifting operations, said matrix provides surface vibration and wave formation.

3. A sifting screen in accordance with claim 1 wherein said matrix is homogeneously elastomeric.

4. A sifting screen in accordance with claim 3 wherein said matrix is made of polyurethane.

5. A sifting screen in accordance with claim 1 wherein said frame comprises multiple hooks, each for maintaining a point on said frame at a corresponding location of attachment to the shaker bed.

6. A sifting screen in accordance with claim 3 wherein said matrix is made of rubber.

7. A sifting screen in accordance with claim 3 wherein said matrix is made of a polymer having a high modulus of elasticity.

8. A sifting screen in accordance with claim 2 wherein said screen portion is generally rectangular and at last one of four edges of said screen portion is bowed outwardly.

9. A sifting screen in accordance with claim 8 wherein said generally rectangular screen portion is defined by two opposite, generally linear side edges and two opposite, outwardly bowed forward and rearward edges.

10. A sifting screen in accordance with claim 9 wherein a hook is mounted at each location of attachment.
